(19) United States
(12) Patent Application Publication
(10) Pub. No.: US 2019/0144699 A1
(43) Pub. Date: May 16, 2019

(54) INKJET INK IMMOBILIZATION COMPOSITION

(71) Applicant: Kornit Digital Ltd., Rosh HaAyin (IL)

(72) Inventors: Muhammad IRAQI, Tira (IL); Jacob MOZEL, Kfar-Saba (IL)

(21) Appl. No.: 16/065,132

(22) PCT Filed: Dec. 22, 2016
(86) PCT No.: PCT/IL2016/051374

§ 371 Date: Jun. 22, 2018

Related U.S. Application Data
(60) Provisional application No. 62/387,154, filed on Dec. 23, 2015.

(51) Int. Cl. C09D 11/54; C09D 11/30; C09D 11/107; B41M 5/00

(52) U.S. Cl. CPC C09D 11/54; B41M 5/0017; C09D 11/107; C09D 11/30

(57) ABSTRACT

Provided herein is an ink immobilizing composition that includes a polymeric agent acting as a property-adjusting agent, capable of causing immobilization of a property-sensitive ink composition upon contact therebetween on the surface of a substrate, as well as a process of printing an image, a kit for printing, and a substrate having an image printed thereon afforded by using the polymer-containing immobilizing composition.

### FIELD AND BACKGROUND OF THE INVENTION

The present invention, in some embodiments thereof, relates to textile printing and, more particularly, but not exclusively, to non-corrosive immobilizing compositions for improved inkjet printing.

The ever growing demand for new and stimulating garment and fabric fashion, one of the greatest commercial markets, challenges cutting edge technology to innovate in areas such as fiber materials, weaving and threading, cloth fabrication, dying and post treatment of textile fabrics. One approach for increasing textile printing speed, quality, versatility and simplicity involves the use of inkjet printing. Since the introduction thereof in the latter half of the 1980s (see, for example, U.S. Pat. Nos. 4,312,007 and 4,380,770), inkjet printers have grown in availability, performance and popularity while dropping significantly in price, mostly due to their reliability, relatively quiet operation, versatility, graphics capability, print quality, and low cost. Moreover, inkjet printers have made possible “on demand” and “roll-to-roll” color printing without the need for complicated devices.

When the desired substrate for printing is a garment or another textile fabric surface, digital inkjet technology is one of the most favorable technique for designer art and image creation. It is relatively cheap and versatile, yet can provide high resolution multicolor and photorealistic images, as many households experience with their low cost, high resolution inkjet home computer printers. The presently available inks for inkjet printing include nonionic, cationic and anionic aqueous-based inks and non-aqueous solvent-based inks. Aqueous-based inks are typically composed of water and a colorant, usually a dye or a pigment dispersion, and may further contain a number of additives for imparting certain features to the ink (e.g., improved stability and flow, feather resistance, and the like). Non-aqueous solvent-based inks are typically composed of one or more volatile organic solvents, such as low alcohols, glycol ethers, low alkanes and the like, and a colorant.

However, fabrics and other textile substrates present challenges to the inkjet printing technology in that the substrates are typically absorptive, flexible and stretchable, oftentimes colored (non-white), and are used in a variety of dynamic and wearing environments, including activewear and sportswear, repetitive washing, drying and folding, and the like.

As inkjet printing technology is a non-contact printing where small size ink drops is being applied directly on different substrates, including textiles, it presents a challenge for achieving high quality sharp images, due to ink drops mobility on the substrate, which must be limited. Ink drop mobility, particularly soaking, spreading and bleeding should be limited on various fabric substrates, since color to color bleeding adversely affects the resulting prints quality. There are number of theories that attempt to explain the mechanisms of color bleeding and offer solutions that are mainly based on chemical or physical reactions/processes between the ink and the pretreated substrate. Most of these solutions require substrate pre-treatment, off line of the printing process and machinery; however, most of these pre-treatments lower the quality of the fabric, degrade some of its most values properties, and jacks-up costs.

PCT Application Nos. WO 2005/115089 and WO 2005/115761, by the present assignee, and which are both incorporated by reference as if fully set forth herein, teach a process, a composition and an apparatus for printing an image on an absorptive surface, such as a textile piece, that includes applying a wetting composition on the surface which is capable of interfering with the engagement of a liquid ink composition with the binding sites of the surface. According to the processes taught in these patent applications, once the wetting composition is applied, the liquid ink composition is applied while the surface is still wet. Using this process, a vivid color image is formed on the absorptive surface. These patent applications, however, fail to address the limitations associated with printing a color image on an absorptive dark surface.

Multi-part ink compositions, which are based on contacting an immobilization composition and a colored ink composition on the surface of a substrate, so as to congeal the colored ink composition on the substrate, thereby minimizing feathering and soaking thereof into absorptive substrates, are also taught in U.S. patent application Ser. No. 11/588,277 (U.S. Patent Application Publication No. 20070104899), U.S. patent application Ser. No. 11/606,242 (U.S. Patent Application Publication No. 20070103529), and U.S. patent application Ser. No. 14/619,218 (U.S. Patent Application Publication No. 20150152274), all of which are incorporated by reference as if fully set forth herein.

U.S. Pat. No. 7,134,749, by the present assignee, which is incorporated by reference as if fully set forth herein, teaches a method and an apparatus for color printing on a dark textile piece which includes digitally printing, by means of an inkjet printer head, an opaque white ink layer directly onto a dark textile piece, and digitally printing a colored image on the white ink layer. One of the main principles in this method is the digital printing of the white ink layer, which is performed such that the white ink layer substantially covers, without exceeding, the designed area of the next to be printed colored image, and further such that the white ink layer and the colored image are substantially coextensive. All the printing steps in this method are performed by essentially using conventional inkjet printing techniques.

U.S. Pat. No. 8,540,358, by the present assignee, which is incorporated by reference as if fully set forth herein, teaches an inkjet ink compositions for forming an image in a form of an elastic film attached to a surface of a stretchable and/or flexible substrate and processes utilizing same for inkjet printing color images on various substrates such as colored and absorptive or impregnable stretchable materials, which are characterized by heightened efficiency in process time, ink and energy consumption, as well as products having durable, wash-fast and abrasion-fast images printed thereon by the process, are disclosed.

### SUMMARY OF THE INVENTION

Embodiments of the present invention relate to an ink-immobilizing composition containing a polymeric property-adjusting agent, which is essentially odorless and imparts no staining or color augmentation on the substrate. This type of polymer-containing immobilizing composition is advantageous over small molecule acids that in some cases impart an unpleasant odor and/or stain the substrate. The polymer is selected to act as a pH-adjusting agent, designed and/or selected to cause immobilization of an ink composition, which includes a property-sensitive agent, upon contact on the surface of a substrate, thereby mitigating the problems associated with ink bleeding and improving the overall quality of the printed image in terms of color gamut and resolution.

According to an aspect of some embodiments of the invention, there is provided an immobilizing composition that includes a property-adjusting agent and an immobilizing composition carrier, and being capable of causing immobilization of an ink composition upon contacting the ink composition, the ink composition comprises a colorant, a property-sensitive agent and an ink composition carrier, wherein the property-adjusting agent is an acidic polymer.

The immobilizing composition includes a property-adjusting agent in the form of an acidic polymer and a carrier, and is capable of causing immobilization of an ink composition upon contact when the ink composition includes a property-sensitive agent, a colorant and a carrier.

In some embodiments, the immobilizing composition is having a pH that ranges from about 2 to about 6.

In some embodiments, the acidic polymer in the immobilizing composition is having a plurality of acidic functional groups attached thereto.

In some embodiments, the acidic functional groups are selected from the group consisting of carboxylic groups, phenol groups, sulfo groups, sulfino groups, aromatic sulfonamide groups, imide groups, phospho groups, phosphono groups and any combination thereof.

In some embodiments, the plurality of acidic functional groups constitute from 40 percent to 70 percent by weight of the molecular weight of the polymer.

In some embodiments, the polymer is having a pKa that ranges from 3 to 5 in water.

In some embodiments, the amount of the polymer in the immobilizing composition ranges from 0.5% to 10% of the total weight of the composition.

In some embodiments, the polymer is characterized by water miscibility of at least 10%.

In some embodiments, the odor threshold of the polymer is higher than 1 ppm by volume of air.

In some embodiments, the polymer is characterized by an average molecular weight that ranges from 4000 g/mol to 20000 g/mol.

In some embodiments, the polymer is selected from the group consisting of polyacrylic acid, acidic alkoxylated polymer, poly(2-acrylamido-2-methylpropanesulphonic acid), poly(acrylic acid-co-maleic acid), poly(butadiene-co-maleic acid), poly(ethylene-co-acrylic acid), polymaleic acid, poly(methacrylic acid), poly(4-styrenesulfonic acid-co-maleic acid), and any mixture thereof.

In some embodiments, contacting the immobilizing composition presented herein and the ink composition is effected on a surface of a substrate.

In some embodiments, the immobilizing composition presented herein is substantially devoid of a colorant. In some embodiments, the immobilizing composition presented herein is essentially colorless and transparent.

In some embodiments, the immobilizing composition presented herein is suitable for direct inkjet printing.

In some embodiments, the immobilizing composition presented herein is designed for application from a nozzle is characterized by at least one of:

a maximal particle size of less than 15 micron;

a dynamic viscosity at shear that ranges from 2 to 4 (N·s)/m²;

a room temperature Brookfield viscosity less than 3 centipoises;

a surface tension that ranges from 24 to 26 N/m; and

an electrical resistance of 50 to 2000 ohm per centimeter.

In some embodiments, the immobilizing composition presented herein is designed for application from a printhead is characterized by at least one of:

a maximal particle size of less than 1 microns;

a dynamic viscosity at shear that ranges from 8 to 20 (N·s)/m²;

a room temperature Brookfield viscosity less than 25 centipoises;

a surface tension that ranges from 24 to 32 N/m; and

an electrical resistance of 50 to 2000 ohm per centimeter.

In some embodiments, the immobilizing composition presented herein further includes a plurality of wax particles and a surfactant (a wax colloid).

In some embodiments, the wax is an oxidized polyethylene wax and the surfactant is a cationic surfactant.

In some embodiments, the immobilizing composition presented herein is substantially devoid of a small molecule organic acid.

In some embodiments, the immobilizing composition presented herein is designed to interact with a property-sensitive agent, which is in a form of a dispersed agent and/or emulsified agent.

In some embodiments, the immobilizing composition presented herein is designed to interact with a property-sensitive agent, which is selected from the group consisting of a resin binder, a dispersing agent, an adhesion promoting agent and a film-forming agent.

In some embodiments, the immobilizing composition presented herein is designed to interact with a property-sensitive agent, which interacts with the immobilizing composition and undergoes congelation or coagulation, and is selected from the group consisting of a polyacrylate, a polyurethane, a polyether, a polyester, a polyvinyl chloride, a polyvinyl acetate, a polyvinyl butyral, an aminosilicon and any co-polymer, salt or combination thereof.

In some embodiments, the property-sensitive agent is a dispersing agent.

In some embodiments, the property-sensitive agent is a resin binder.

In some embodiments, the property-sensitive agent is a film-forming agent.

In some embodiments, the immobilizing composition carrier is an aqueous carrier.

In some embodiments, the ink composition carrier is an aqueous carrier.

According to an aspect of some embodiments of the invention, there is provided a substrate having an image printed thereon, wherein the image is in the form of a film attached to the substrate and the film is formed by contacting the substrate with the immobilizing composition presented herein, and applying the ink composition on the substrate, thereby forming the image.

In some embodiments, the odor threshold of the film is higher than 1 ppm by volume of air.

In some embodiments, the substrate is substantially devoid of substrate color augmentation around the film, namely in areas that received the immobilizing composition but not the ink composition.

According to an aspect of some embodiments of the invention, there is provided an inkjet printing kit which includes the immobilizing composition presented herein and the ink composition.

In some embodiments, each of the immobilizing composition and the ink composition in the kit are packaged separately in a packaging material.

In some embodiments, the immobilizing composition in the kit is identified in print, in or on the packaging material, for use in immobilizing the ink composition upon contacting the ink composition.

According to an aspect of some embodiments of the invention, there is provided a process of printing an image on a substrate, which includes contacting at least a portion of the substrate with the immobilizing composition presented herein, and applying the ink composition on the portion of the substrate, thereby printing the image.

In some embodiments, the immobilizing composition presented herein and the ink composition are each individually applied on the portion of the substrate by a separate applicator.

In some embodiments, the immobilizing composition presented herein is applied by a nozzle.

In some embodiments, the immobilizing composition presented herein applied by an inkjet printhead.

In some embodiments, the immobilizing composition presented herein, and the ink composition, are applied concertedly, concomitantly or sequentially.

In some embodiments, the immobilizing composition presented herein is applied in-line with the ink composition.

In some embodiments, the ink composition is applied on the substrate while the substrate is still wet with the immobilizing composition presented herein.

In some embodiments, the process presented herein further includes a step of curing the image subsequent to the applying the ink composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SPECIFIC EMBODIMENTS OF THE INVENTION

The present invention, in some embodiments thereof, relates to textile printing and, more particularly, but not exclusively, to non-corrosive immobilizing compositions for improved inkjet printing.

The principles and operation of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As mentioned hereinabove, off-line substrate pre-treatments have been suggested and some are even implemented in the industry, in order to solve the problems associated with ink bleeding on absorptive substrates, yet these solutions are far from satisfactory when considering the wider and dynamic field of fashion and inkjet applications associated therewith.

As further presented above, the problem of ink bleeding is mitigated by using a multi-part ink system wherein a pH-sensitive colored ink composition is immobilized as a result of being contacted with an immobilization composition containing a transitory (volatile or degradable) organic acid. However, use of an organic acid, even transitory acids, to cause the coagulation and immobilization of the colored ink composition on the substrate has given rise to several problems, at least in some inkjet printing applications and conditions.

Among some of the problems associate with using small-molecule organic acids to coagulate pH-sensitive ink compositions, the more adverse problems include:

1. damaging acid-sensitive printing machinery parts;

2. causing blockage of the printheads due to the volatility of the acid in the immobilization composition, allowing acidic fumes to reach the pH-sensitive ink composition in the printhead before it has been printed;

3. remnants of acid impart an unpleasant odor even at traces amount which are left in the substrate and the printed film (image) after the process, regardless of considerable attempts to eliminate the smell; and

4. some non-volatile and volatile organic acids leave a noticeable stain in some of the fabrics used as substrates, particularly dyed substrates.

In search for a solution to the aforementioned problems, the present inventors have contemplated a property-adjusting agent (a substance) that can cause a property-sensitive agent in the ink composition to coagulate upon contact on the substrate, and yet be suitable for adding into a nozzle-sprayable or printhead-jettable composition, while not harming the printing machinery (corrosion and/or blockage), the substrate (staining and/or burnout), or the environment (odor and/or fumes).

While searching for a suitable property-adjusting agent, the inventors have found that a certain family of polymers, the members of which are capable of imparting a low pH when in aqueous medium, provides the solution to the aforementioned problems, while serving as an effective property-adjusting agent. For example, polymers of the family of anionic water soluble copolymers such as a modified vinyl pyrrolidone-vinyl acetate copolymer were found useful as property-adjusting agent. In the exemplary embodiments modified vinyl pyrrolidone-vinyl acetate copolymer, carboxylic groups on the backbone of the polymer develop anionic charges along the polymer backbone, and as a result the polymer becomes solubilized in water while imparting low pH conditions in neutral water, and as a result of the reaction between the polymer-containing immobilizing composition and the ink composition that contains an acid-sensitive agent, the ink composition is immobilized.

While reducing the present invention to practice, several advantages stem from the use of acidic polymers in place of small molecule acids:

i. polymer-containing immobilizing composition can be applied by jetting/spraying directly to fabrics to achieve ink immobilization;

ii. polymer-containing immobilizing composition is odorless after application and drying of the printed textile substrate as it contains no small molecule volatile acids such as acetic acid;

iii. polymer-containing immobilizing composition jetting properties are more controllable compared to small molecule-containing immobilizing composition;

iv. polymer-containing immobilizing composition is more compatible with inkjet printheads compared to small molecule-containing immobilizing composition.

The presently provided polymer-containing immobilizing compositions were found useful in producing color images which do not give-off noticeable odor, and in not staining the substrate which is wetted thereby, while mitigating ink bleeding to afford high resolution images. The polymer-containing immobilizing compositions were found effective on substrates made from natural or synthetic fibers, such as polyester textiles. The use of the presently provided polymer-containing immobilizing compositions also reduced substrate dye migration of printed colored polyester textiles. In addition to the above benefits, the polymer-containing immobilizing compositions also improved the anti-scuff and hand-feel properties and color stability of the printed substrates.

### Polymer-Containing Immobilizing Composition:

According to an aspect of some embodiments of the present invention, there is provided an ink immobilizing composition that includes a property-adjusting agent and a carrier, wherein the property-adjusting agent is a polymer (polymeric property-adjusting agent).

According to embodiments of the present invention, the immobilizing composition containing the polymeric property-adjusting agent (polymer-containing immobilizing composition) is capable of causing a change in an ink composition that leads to the immobilization of the ink composition that includes a colorant, a property-sensitive agent and a carrier, whereas the immobilization of the ink droplets is effected upon contacting the two compositions, as discussed in detail hereinbelow.

Briefly, the immobilization of the ink composition is generally effected on at least a portion of a surface of a substrate with the aim of limiting or arresting soaking, spreading and feathering of the ink composition in/on the surface of the substrate, collectively referred to herein a as “bleeding”, particularly when inkjet-printing the ink composition on an absorptive substrate, such as textile. The inclusion of a polymer in the immobilizing composition further assists in modifying the surface-tension of the composition such that the composition is less prone to soaking into, or spreading onto the substrate, and providing the finished and cured printed image, in the form of a film, improved color resolution properties. According to some embodiments of the present invention, the substrate is a textile substrate, such as a woven or non-woven fabric, a cloth, a garment and/or a piece of clothing.

Quantitatively, “immobilization” in the context of embodiment of the present invention is defined as elevating the viscosity of the color-bearing ink composition by 10-folds, 50-folds, 100-folds, 500-folds 1000-folds or 2000-folds and more. For example, when a given color-bearing ink composition is characterized by having a viscosity of 10-13 cp, it is defined as immobilized when its viscosity is elevated to about 2000 cp or higher as a result of congelation. In some embodiments, the term “immobilization” is used to refer to a sharp increase in viscosity of a liquid, such that droplets of the liquid are less prone to flow, soaking, bleeding, spreading and feathering.

Hence the chemical and/or physical change, which affects the droplets of liquid ink composition, according to some embodiments of the present invention, is generally referred to herein as “immobilization”. In the context of the chemical and mechanical change that occurs in the ink composition, according to some embodiments of the present invention, the term “immobilization”, as used herein, is interchangeable the terms “coagulation”, “congelation”, “flocculation”, “precipitation”, “thickening” or “gelation”, and refer to the sharp decrease in fluidity of a formerly fluid liquid. Coagulation can be effected also by, or seen as sedimentation, precipitation, partial solidification and partial polymerization of soluble constituents in the composition. The term “sedimentation”, as used herein, refers to the destabilization of suspended colloidal or emulsified substances, such as pigment particles. The term “flocculation”, as used herein, refers to the bridging between particles by a polymer chain, causing them to form flocs or larger aggregates that might sediment or precipitate.

According to some embodiments of the present invention, the polymer-containing immobilizing composition is formulated to carry and deliver a polymeric property-adjusting agent, and does not contain a colorant and is thus substantially transparent and colorless, and intended not to leave a distinguishable mark on the substrate. Thus, according to some embodiments of the present invention, the polymer-containing immobilizing composition is essentially devoid of a colorant.

The term “colorant”, as used herein, describes a substance which imparts the desired color to the printed image. The colorant may be a pigment or a dye. Pigments are solid colorants with are typically suspended in the carrier of the ink composition as dispersed particles, whereby dyes are colorants which are dissolved in the carrier of the ink composition. Some dyes may be insoluble liquids which form emulsions with the carrier.

As used herein, the term “polymer” is meant to encompass all types of polymers, including single-monomer polymers (homopolymers), co-polymers, alternating co-polymers, periodic co-polymers, statistical co-polymers and block co-polymers, as these terms are known in the art, as well as mixtures of polymers.

The term “polymer”, as used herein, is a molecule, which includes a plurality of backbone units, linked to one-another via linking moieties and/or bonds, and these terms are known in the art. Typically the backbone units are moieties of small molecules, referred to herein and in the art as monomers. Polymers are distinguished from small molecules based also on their average size, or molecular weight. This difference also leads to notable differences in melting and boiling point compared to small molecules.

According to some embodiments, the polymeric property-adjusting agent is characterized by an average molecular weight larger than 1500 g/mol, larger than 3000 g/mol or larger than 400 g/mol. In some embodiments, the average molecular weight of the polymeric property-adjusting agent ranges from about 4000 g/mol to about 20000 g/mol.

As used herein, the term “small molecule” is used to distinguish polymers from other substances in the context of some embodiments of the present invention, and refers to molecules that have a relatively low molecular weight. Typically, small molecules are monomeric or oligomeric (polymers having a limited number of monomeric units, e.g., 2-50) and have a molecular weight lower than about 1500 g/mol (gram per mol, or Dalton, Da).

In some embodiments of the present invention, the polymer-containing immobilizing composition may include one or more polymeric property-adjusting agent in a total amount that ranges from about 0.1% to about 20% of the total weight of the composition, or 0.5-15%, 0.5-10%, 0.1-5%, or 0.5-4%, or 0.5-3%, or 1-4%, or 1-3%, or 1-2% polymeric property-adjusting agent of the total weight of the composition. If one or more polymeric property-adjusting agent is utilized, each polymeric property-adjusting agent may be present in any ratio between 0 and 100% comprising the blend as long as the total amount of the polymeric property-adjusting agent in the immobilizing composition is within the desired range.

The polymer-containing immobilizing composition presented herein is formulated so as to be suitable for application thereof in-line of an inkjet printing process. In other words, the immobilizing composition is designed to be applied directly on the substrate as part of the printing process rather than a pre-treatment step before the printing process, which can take place off-line of the inkjet printing process. Such formulation incurs some limitations of the immobilizing composition, particularly in the sense that the composition is required to be suitable for inkjet applicators that form a part of the inkjet machinery, and particularly the parts that involve direct inkjet printing.

The mechanical properties of the polymer-containing immobilizing composition presented herein are correlated, at least to some extent, to the properties of the liquid applicator used to apply the composition on the substrate. Suitable applicators include high-output capacity spray nozzles that are typically used to cover relatively large area of the substrate at relatively low resolution, and inkjet printheads, the latter being more delicate and complex and used for accurate drop placement (high resolution) at relatively low-output capacity. For simplicity, the term “nozzle” is used herein to refer to the high-output low resolution liquid applicator, and the term “printhead” is used to refer to the low-output high resolution liquid applicator. Output capacity may also be affected by the relative speed by which the applicator moves over the substrate (or the substrate moves under the applicator) during the printing process, however the output capacity is determined while taking that relative motion into account by reporting the total amount of liquid that is being delivered to a unit area at a unit time. A typical printhead delivers ink according to the varied digitized color requirements at any given image segment (“pixel”), pallet motion and printhead frequency, while a typical spray nozzle delivers constant amount under constant pressure of liquid over time, varied by pallet motion. For an exemplary comparison, a spray output capacity of a nozzle ranges about 4-5 grams per square inch at a pressure of about 1.5 bar, while the jetting output capacity of a printhead ranges about 0.02-0.05 grams per square inch.

According to some embodiments, when the polymer-containing immobilizing composition is designed to be applied (sprayed) by a nozzle, its ingredients are selected and/or treated such that the composition exhibits (characterized by) at least one of the following attributes:

a maximal particle size of less than 10, 15 or 20 microns;

a dynamic viscosity at shear that ranges from 2 to 4 (N·s)/m²;

a room temperature Brookfield viscosity less than 3 centipoises;

a surface tension that ranges from 24 to 26 N/m; and

an electrical resistance of 50 to 2000 ohm per centimeter.

According to some embodiments, when the polymer-containing immobilizing composition is designed to be applied (jetted) by a printhead, its ingredients are selected and/or treated such that the composition exhibits (characterized by) at least one of the following attributes:

a maximal particle size of less than 1, 5 or 10 microns;

a dynamic viscosity at shear that ranges from 8 to 20 (N·s)/m²;

a room temperature Brookfield viscosity less than 25 centipoises;

a surface tension that ranges from 24 to 32 N/m; and

an electrical resistance of 50 to 2000 ohm per centimeter.

According to some embodiments of the present invention, the polymer-containing immobilizing composition is a water-based composition, and the immobilizing composition carrier is an aqueous carrier, or water.

According to some embodiments of the present invention, the pH of the polymer-containing immobilizing composition is acidic due to the nature of the polymeric property-adjusting agent, as discussed hereinbelow. In such embodiments, the pH of the polymer-containing immobilizing composition ranges about 2-6, or about 2-5, or about 2-4. Optionally, the pH of the polymer-containing immobilizing composition ranges about 3-6, 4-6 or 5-6. The polymer-containing immobilizing composition may or may not contain a buffering agent. According to some embodiments, a polymer-containing immobilizing composition may be buffered by a suitable salt or weak base, such as ammonia/ammonium base or another volatile amine, to ensure the desired pH range while not leaving undesired traces on the substrate. Buffering may be accomplished by a buffering agent, such as, but not limited to a weak amine such as tris(hydroxymethyl aminomethane), also referred to as Tris or THAM.

Polymeric Property-Adjusting Agent:

One of the objectives of using an immobilizing composition containing a property-adjusting agent as one (first) part, and an ink composition containing property-sensitive agent in a separate (second) part, is to provide the means to congeal and thereby immobilize the ink composition only upon contacting the two parts on the surface of the substrate and not beforehand, thus avoiding clogging of the delicate elements of the printing machine. The property-adjusting agent is selected such that it effects a change in the property-sensitive agent, thereby effecting congelation of the ink composition.

The term “property” in the context of a “property-adjusting agent”, as used herein, refers to a chemical and/or physical property of an ingredient in the ink composition that is sensitive to the presence or to an increase in the amount of the property-adjusting agent—a sensitivity that is expressed inter alia by losing the ability to stay dispersed or emulsified. In other words, the presence or an increase in the amount of the property-adjusting agent causes a property-sensitive agent in the ink composition to break the suspended or the emulsified state of the ink composition (dispensability), leading to immobilization thereof. Representative examples of such properties include, without limitation, acidity (pH), metal atom complexation (metal ion concentration), ionic strength and hydrophobicity.

Hence, the phrase “property-adjusting agent” as used herein refers to a component in the polymer-containing immobilizing composition that can affect the dispensability of an ink composition comprising a property-sensitive agent, such that when the immobilizing composition and the ink composition come in contact and combine, the ink composition congeals. For example, an acid, acting as a property-adjusting agent in the immobilizing composition, will change pH level of the ink composition, causing a pH-sensitive agent therein to precipitate, thereby causing the ink composition to congeal or coagulate. By effecting a change in one or more such properties, the property-adjusting agent is causing the property-sensitive agent to undergo a chemical and/or physical change (such as congelation or coagulation), as discussed herein. Hence, in some embodiments, a metal-ion-ligand complexation, a sharp change in the ionic strength, a sharp change in the hydrophobicity or a sharp change in the electric charge/valency of the ink composition, will cause it to congeal or coagulate.

An exemplary property is a pH-dependent dispensability and ionic-strength-dependent dispensability, wherein the change in pH (the aforementioned acidity or alkalinity property) or the ionic-strength of a solution changes the dispensability of one or more of its dispersed species. Similarly, there exist inter-dependency between metal ion complexation combined with pH, and the capacity to stay emulsified (dispersed), and such interdependency is discussed in detailed hereinbelow.

The phrase “polymeric property-adjusting agent”, as used herein, refers to a property-adjusting agent which is a polymer. A polymeric property-adjusting agent that acts by adjusting the pH of the environment of a pH-sensitive agent, is therefore a polymeric pH-adjusting agent. According to some embodiments, a polymeric property-adjusting agent is an acidic polymer. Alternatively, according to some embodiments of the present invention, the chemical property is pH-dependent dispensability, and the corresponding polymeric property-adjusting agent is an acidic polymer.

Although most acids will cause an ink composition containing a pH-sensitive agent to congeal, some acids might be less preferable for use in some embodiments and printing conditions and tasks. According to some embodiments of the present invention, the polymer-containing immobilizing composition is substantially devoid of a small molecule acid. According to some embodiments of the present invention, the polymer-containing immobilizing composition does not include a small molecule acid, such as a small molecule organic acid. Excluded small molecule acids include acids that impart a noticeable odor, or may burn-out the substrate, or leave a stain in the substrate, or cause a dye in the substrate to migrate. According to embodiments of the present invention, particularly excluded are acetic acid (strong vinegar odor even after curing), butyric acid (unpleasant rancid butter odor), lactic acid (dimerized at curing to a staining lactide), and malic, ascorbic, maleic and benzoic acids (tend to leave a solid residue and burn fabric substrates.

One of the advantages of using an acidic polymer, is the refrainment of including a small molecule acid in the immobilization composition. Unlike acidic polymers, small molecule acids may be more corrosive on the fabric as well as on the delicate parts of the printing apparatus and particularly the printheads and other metallic and otherwise delicate parts of the printing machine. Small molecule acids may be volatile and therefore their acidic fumes may be more damaging to the substrate, machinery and environment. Hence, the choice of an acidic polymer, which is effective enough to cause the desired property-adjusting effect, is also made so as not to damage the machinery and/or garment, and mild enough and not odoriferous so as not to degrade the finished product. The acidic polymeric property-adjusting agent is beneficial also for its low boiling point, being higher than 200° C., and therefore is not volatile at ambient and printing conditions, lowering the risk of damaging the machinery and less likely to have noticeable odor.

According to embodiments of the present invention, the polymeric pH-adjusting agent, or the acidic polymer, is selected according to the ability to increase the concentration of hydrogen ions (H⁺), or more accurately, hydronium ions (H₃O⁺), when dissolved in water. An acidic polymer is also one that exhibits a plurality of acidic functional groups attached thereto, essentially as side-chain groups and/or tail (termini) groups. Acidic functional groups are chemical moieties that are capable of releasing H⁺ or H₃O⁺ ions into an aqueous media, become negatively charged and decrease the pH of the media.

Some examples of acidic functional groups include carboxylic groups, phenol groups, sulfo groups, sulfino groups, sulfonamide groups, aromatic sulfonamide groups, imide groups, phospho (phosphate) groups and phosphono groups. The backbone of the polymer may exhibit one or more types of acidic functional groups.

A used herein, a “carboxylic group” refers to an RCO₂H group, wherein R represent the polymer.

A “phenol group”, as used herein, refers to an R—(C₆H₄)—OH group.

A used herein, a “sulfo group” refers to an RSO₃H group.

A used herein, a “sulfino group” refers to an RSO₂H group.

A used herein, a “sulfonamide group” (also spelt sulphonamide) refers to an RS(═O)₂—NH₂ or RS(═O)₂—NR′H group, where R′ is a low (C₁₋₅) alkyl.

The term “imide” or “imido” group, as used herein, refers to a (RCO)₂NR′ group.

The term “phosphono group”, as used herein, refers to an RP(═O)(OH)₂ group.

As used herein, the term “phosphate group” refers to an ROP(═O)(OH)₂ group or an ROP(═O)(OR′)(OH) group.

In some embodiments of the present invention, the amount of acidic functional groups, forming a part of the acidic polymer, constitute from about 40 percent to about 80 percent by weight of the molecular weight of the polymer, or 50-70%, or 40-60%. For example, in polyacrylic acid (PAA), the amount of carboxylic groups is about 60 percent of the total weight of PAA.

When comprising a plurality of acidic functional groups, an acidic polymer is capable of exhibiting a pKa (dissociation constant) that ranges from about 3 to about 5. In some embodiments, the polymeric property-adjusting agent exhibits a pKa of about 4, 4.25, 4.5, 4.75 or 5. For example, the pKa of poly(acrylic acid) (PAA) is about 4.2.

According to some embodiments, the polymeric property-adjusting agent (the polymer) is substantially soluble in water, hence, the polymer is characterized by water miscibility of at least 10% in water. Alternatively, the polymer is selected capable of forming at least a 5%, 10%, 12%, 15%, or at least 20% aqueous solution.

Excluded from the scope of the definition of an acidic polymer, according to embodiments of the present invention, are acidic polymers that may cause burn-out of the substrate or any parts thereof, such as burn-out of cellulosic fibers in a fabric substrate. Thus, according to some embodiments of the present invention, the immobilizing composition is formulated with an acidic polymer that cannot cause burn-out of elements in the substrate, either by selecting an acidic polymer that is incapable of such burn-out, and/or an acidic polymer used in a concentration that is insufficient to cause such burn-out. Also excluded from the scope of the definition of an acidic polymer, according to embodiments of the present invention, are polymers that act as blocked acids, acid catalysts and polymers that release acid molecules upon heating. For example, excluded from the scope of the definition of an acidic polymer, according to embodiments of the present invention, are polymers that release acid molecules upon heating since these polymers may cause burn-out the substrate during the curing step of the printing process, while their acidic nature that is required before the curing step for immobilizing the ink composition.

As a polymer, the polymeric property-adjusting agent is characterized by a high boiling point relative to the boiling point of small molecule acids. The high boiling point and the structural and chemical composition of the polymer are also conducive to imparting relatively low level of odor. In other words, the polymeric property-adjusting agent is characterized by having little or no odor, or imparting less than noticeable odor, or at least imparting less odor than acetic acid.

The odor level of a substance may be determined by many methods, procedures and techniques, including personal, subjective to a group of trained or untrained persons, and a chemical-based measurement. In some embodiments of the present invention, the odor level of a substance is determined substantially as described in “Odor Threshold Determinations of 53 Odorant Chemicals”, by Leonardos, G. et al., Journal of the Air Pollution Control Association, 1969, 19(2), pages 91-95, or in “Odor Thresholds and Irritation Levels of Several Chemical Substances: A Review” by Ruth, J. H., American Industrial Hygiene Association Journal, 1986, 47(3), pages 142-151. For example, acetic acid is characterized by a distinctive odor of vinegar, which is noticeable at 1 ppm (by volume) or 2.5 mg/m³.

Thus, according to some embodiments, the odor threshold (noticeable level) of polymeric property-adjusting agent (the polymer) is higher than 1 ppm by volume of air. Alternatively, the odor threshold of the polymer is higher than 1 ppm, 2 ppm, 4 ppm, 6 ppm, 8 ppm, 10 ppm, 12 ppm, 14 ppm, 20 ppm, 25 ppm or 50 ppm by volume, or higher than 2.5 mg/m³, 5 mg/m³, 10 mg/m³, 15 mg/m³, 20 mg/m³, 30 mg/m³, 50 mg/m³, 100 mg/m³, or higher than 150 mg/m³.

Exemplary acidic polymers, which can be used beneficially as polymeric property-adjusting agent in the context of embodiments of the present invention, include, without limitation, polyacrylic acid, acidic alkoxylated polymer, poly(2-acrylamido-2-methylpropanesulphonic acid), poly(acrylic acid-co-maleic acid), poly(butadiene-co-maleic acid), poly(ethylene-co-acrylic acid), polymaleic acid, poly(methacrylic acid), poly(4-styrenesulfonic acid-co-maleic acid), and any mixture thereof.

### Ink Composition Designed for Immobilization:

The polymer-containing immobilizing composition presented herein is designed to interact with a suitable colored ink composition, referred to herein in short as “ink composition”, namely the liquid formulation that carries a colorant to the surface of the substrate, thereby forming a printed image or design thereon. In some embodiments, the immobilizing composition is substantially devoid of a colorant, and is therefore colorless and imparts no color to the substrate.

The ink composition, comprises a colorant, a property-sensitive agent and a carrier. The ink composition may further include other ingredients, such as a resin binder, a film-forming agent, an adhesion promoting agent and a dispersing agent.

According to some embodiments, the property-sensitive agent is in a form of a dispersed agent and/or emulsified agent. In such embodiments, the presence of the property-adjusting agent causes the property-sensitive dispersed agent and/or property-sensitive emulsified agent to break out of its dispersed and/or emulsified state and cause immobilization of the composition. The immobilization of the ink composition is caused by coagulation or congelation of the property-sensitive agent, which leads to immobilization of the colorant (typically a pigment) and to notable limitation of its soaking and bleeding capacity.

In some embodiments, the emulsified and/or dispersed property-sensitive agent is an alkali-soluble polymer, which is a polymer that in its neutral or free-acid form is immiscible or almost immiscible in water, but can be turned miscible, emulsified or dispersed in water when it is rendered alkali by buffering with an organic base, such as an amine, or an inorganic base.

In some embodiments, the property-sensitive agent is at least one of the group consisting of a resin binder, a dispersing agent, an adhesion promoting agent and a film-forming agent. In some embodiments, the property-sensitive agent is a dispersing agent, such as used for dispersing pigments. In some embodiments, the property-sensitive agent is a resin binder, such as used to improve the cohesion of the film. In some embodiments, the property-sensitive agent is an adhesion promoting agent, such as used to improve the adhesion of the film to the substrate. In some embodiments, the property-sensitive agent is a film-forming agent.

In some embodiments the properties of binding, film-forming, adhesion promotion and dispersion are combined into one or two or three agents, namely an agent in the ink composition may carry out more than one of the functions of binding, film-forming, adhesion promotion and dispersion.

In some embodiments, the property-sensitive agent is an emulsified or dispersed alkali-soluble polymer selected from the group consisting of a polyacrylate, a polyurethane, a polyether, a polyester, a polyvinyl chloride, a polyvinyl acetate, a polyvinyl butyral, an aminosilicon and any co-polymer, salt or combination thereof.

Any one of the above resin binder, a dispersing agent, an adhesion promoting agent and a film-forming agent, and other optional and/or additional ingredients of the ink composition may also confer stretchability to the resulting image. Such agents are generally referred to herein as proto-elastomeric film-forming agents which imparts elastic stretchability. In some embodiments the proto-elastomeric film-forming agent is also the property-sensitive agent, and in some embodiments the proto-elastomeric film-forming agent is not the property-sensitive agent. In general, when proto-elastomeric film-forming agents co-polymerize, crosslink and cure and thereby affix to the substrate, a soft, flexible and stretchable elastic film is formed which is characterized by a relatively low Tg.

According to some embodiments of the present invention, the ink composition is a water-based inkjet ink composition, thus the carrier of the ink composition is an aqueous carrier or water.

The ink compositions contemplated within the scope of the present invention, may carry transparent or translucent colorants. The basic colorants in inkjet ink compositions are required to be transparent or translucent, since only a few (typically 3-8) basic colors are used and the full spectrum of colors and shades is achieved when these basic colors are perceived by the eye as mixed in various combinations on the substrate. However, direct printing of multicolor images using transparent inks on any surface requires the surface, which is the background of the image, to be white or at least lightly-colored, since its inherent color participates in the formation of the final perceived color, together with the colorant in the inks applied thereon. Surfaces of darkly colored or non-white substrates tend to render the primary-colored ink drops indistinguishable or substantially color-skewed since the final perceived color stemming from any combination of the primary colors is a subtraction of that particular combination from the color white, or at least from a bright light color. It is therefore a physical requirement that the background of an image generated directly onto a surface be a bright light color or white.

To overcome the problem of printing on a non-white substrate, an opaque white underbase layer may be printed on the substrate before the translucent colored ink composition is printed. This opaque underbase layer is afforded by an opaque ink composition, according to some embodiments of the present invention. The opaque ink composition, according to some embodiments of the present invention may also contain a property-sensitive agent, and thus may be designed to congeal upon contacting the polymer-containing immobilizing composition presented herein.

According to some embodiments, the opaque ink composition is essentially white, affording an opaque white layer when jetted on a darkly-colored or non-white surface. According to some embodiments, the white opaque pigment is suitable-sized particles of a metal oxide, such as, for example, titania (titanium oxide).

According to some embodiments, in order to serve as an underbase for a stretchable and flexible image, the opaque underbase should also be stretchable, with a high elongation factor that enables the image printed thereon to maintain its background when stretched with the substrate, without having the (colored) substrate to be seen therethrough and without having the image or the underbase crack under physical pull and tug.

The opaque ink composition, according to some embodiments of the present invention, is suitable for inkjet printing of “spot” colorants, which are substantially opaque colored inks. Spot colorant can be jetted like any other transparent colorants, and are typically used to generate special effects in order to afford highlights and emphases over the image usually in pre-defined coloration.

In general, any reference to an ink composition made herein, should be taken as referring to any translucent ink composition of any color, and to any opaque ink composition of white or any other spot color, unless stated otherwise.

A Process of Printing Rub-Resistant Inkjet Prints:

The process, according to embodiments of the present invention, is based on the use of multi-components (parts) ink compositions, wherein all of the components (parts) are formulated and selected to be suitable also for the main inkjet printing techniques, such as the “drop-on-demand” technique and the likes, as these techniques are familiar to any artisan skilled in the art. Therefore, according to embodiments of the present invention, each of the immobilizing and/or ink compositions used in the processes presented herein is for use in an inkjet printing machine, wherein each compositions is applied (jetted, printed) from at least one different designated printhead and/or nozzle.

The process presented herein is directed at a typical inkjet technique, as known in the art, which is performed using standard or proprietary printheads and other printing machinery.

The polymer-containing immobilizing composition presented herein is used to cause congelation of any ink composition, translucent or opaque, as long as it contains a property-sensitive agent. This instant immobilization of the jetted droplets of the ink composition subsequently promotes improved color and detail resolution of the image, as well as improved contact between the colorant(s) in the ink composition and the substrate, which is effected by better adhesion of the medium containing the colorant (pigment and/or dye) therein to the substrate. The binding, cohesion and adhesion of the medium containing the colorant may be effected by, for example, direct heat-activated chemical crosslinking or entanglement of polymerizable components in the ink composition with functional groups in the substrate.

According to an aspect of embodiments of the present invention, there is provided a process of printing an image on a substrate, which includes contacting at least a portion of the substrate with the polymer-containing immobilizing composition presented herein, and applying the ink composition presented herein on at least some of that portion of the substrate, thereby printing the image.

According to some embodiments of the present invention, the process is effected by digitally applying, by means of a plurality of inkjet printheads and/or nozzles, onto at least a portion of a surface of the substrate, any of the polymer-containing immobilizing composition and ink compositions presented herein, jointly referred to herein as a multi-part ink composition, which are formulated to be suitable for use in inkjet printheads and/or nozzles.

Since each of the immobilizing and/or ink composition used in the process presented herein is jetted by a digitally-control liquid applicator, the areas onto which each composition is applied can essentially overlap, covering substantially the same area of the image (coextensive areas). In particular, the polymer-containing immobilizing composition, which is essentially colorless and transparent, is applied onto the surface as a silhouette of the image, namely as a solid outline and featureless interior of the image. The silhouette may be somewhat larger that the image that will be printed thereon by 1-30%, or by 1%, 5%, 8%, 10%, 15%, 20%, 25%, or 30%. This digital control of applying the immobilizing composition further contributes to the reduction in the amount needed to effect immobilization of the ink composition, as the immobilizing composition does not form extending margins peripheral to the image, or form controllable extending margins. This effect also widens the scope of suitable substances which can be used to formulate the polymer-containing immobilizing composition, as staining of unprinted areas of the substrate which are not covered by colorants, is no longer a problem.

As presented hereinabove the polymer-containing immobilizing composition and the ink composition, are each individually applied on the substrate by a separate applicator (nozzle and/or printhead) so as to keep the property-adjusting agent and the property-sensitive agent apart at all times before applying them on the substrate.

According to some embodiments, the immobilizing composition is applied by a nozzle and the ink composition is applied by an inkjet printhead. According to some embodiments both the immobilizing composition and the ink composition are applied by separate inkjet printheads, referred to herein as the first printhead and the second printhead, respectively.

The printing process is designed and programmed such that the various compositions are applied concomitantly (or essentially simultaneously) on the surface of the substrate by a digitally controlled precise mechanism, and that every drop in the color/pigment-containing parts of the ink composition will come in contact with the polymer in the polymer-containing immobilizing composition. The sequential order by which the immobilizing composition and ink composition are applied on the substrate can be any order, as long as the two types of liquid compositions come in contact therebetween before one of the compositions dries. Hence, according to some embodiments the immobilizing composition and the ink composition are applied concertedly, concomitantly or sequentially. In some embodiments, the ink composition is applied on the substrate while the substrate is still wet with the polymer-containing immobilizing composition, or vice versa (in the reversed order).

The process presented herein, according to some embodiments thereof, is effected by applying all the various compositions, or parts of the multi-parts ink composition, by means of separate inkjet printheads/nozzles concurrently, substantially concomitantly, or very near concomitant application thereof. The term “concomitantly”, as used herein, refers to the timing of one or more occurrences which take place concurrently, or almost concurrently, namely within a short time interval. According to embodiments of the present invention, this short time interval is less than one second, less than 3 seconds, less than 5 seconds, less than 10 seconds, less than 20 seconds, less than 30 seconds, less than 40 seconds, less than 50 seconds or less than 60 seconds between contacting the surface of the substrate with the immobilizing composition and contacting the surface of the substrate with the ink composition, or vice versa (in the reversed order). According to some embodiments, the time gap or interval between applying the immobilizing composition and the ink composition is shorter than about 1-10 seconds. The time interval is regarded as the time the lapses between the time a droplet of a composition containing a property-adjusting agent or property-sensitive agent contacts the substrate, and the time a droplet of the counterpart component contacts the same region of the substrate. According to some embodiments of the present invention, this time interval can be shorter than 0.75 second, shorter than 0.50 seconds and even shorter than 0.25 seconds.

Since all the parts of the multi-part ink composition can be applied on the substrate by means of printheads/nozzles which jet very small droplets of liquids at a controllable rate, one of the advantages of the process presented herein, is a considerable reduction in the total amount of applied liquids which are required to form a vivid and durable image of the substrate, a factor that translates directly into reduced drying and curing times, leading to a great reduction in energy costs.

According to some embodiments, the process presented herein further includes a curing step, at which the ink composition forming the printed image is subsequently cured. Curing can be effected by heating, irradiating or pressing the substrate. According to some embodiments, curing is effected by hot air convection that heats and dries the substrate.

### Kits for Printing an Image:

Any of the compositions presented herein, can be provided to a user in the form of a kit. The term “kit”, as used herein, refers to a single package containing any collection of items or components needed for a specific purpose, especially for use by a user or an operator.

According to an aspect of some embodiments of the present invention, there is provided a kit that includes a packaging material, a polymer-containing immobilizing composition, according to embodiments of the present invention, and at least one ink composition, according to embodiments of the present invention.

According to some embodiments of the present invention, the kit is in a form wherein some of the ingredients of any one of the compositions presented herein, are packaged individually (separately) within the kit. According to some embodiments of the present invention, the kit may include one or more of the compositions in a ready-for-use form, packaged together within the kit.

According to some embodiments of the present invention, the kit contains at least two separate containers for each of the polymer-containing immobilizing composition and the ink composition, and can be used for loading two separate inkjet printheads or nozzles with their contents in preparation for an inkjet printing process, as described hereinabove.

In some embodiments, the packaging material is identified in print for use in printing an odorless image on a substrate that is effected by coagulating the ink composition upon contacting it with the polymer-containing immobilizing composition.

The kit may further include instructions for the user that includes the following directives:

Load the polymer-containing immobilizing composition to a first printhead or nozzle;

Load the ink composition to a second printhead; and

Contact the polymer-containing immobilizing composition with the ink composition by inkjet printing the compositions on a substrate.

The kit may further include other ink compositions, such as translucent colored compositions and/or opaque white or colored compositions packaged individually within the kit.

Odorless Printed Image:

According to an aspect of some embodiments of the present invention, there is provided a substrate, such as for example a textile substrate, having an image printed on at least a portion thereof using the polymer-containing immobilizing composition presented herein, and an ink composition as presented herein. According to some embodiments, the image is in the form of a film attached to the substrate and the film is formed by contacting the substrate with the polymer-containing immobilizing composition presented herein, and applying the ink composition on the substrate, thereby forming the image.

As presented hereinabove, the polymer is selected to exhibit a low level of noticeable odor. Thus, according to some embodiments of the present invention, the film (image) on the substrate, and thus the substrate having the image printed thereon, is characterized by an odor threshold higher than 1 ppm by volume of air. Alternatively, the odor threshold of the film/substrate is higher than 1 ppm, 2 ppm, 4 ppm, 6 ppm, 8 ppm, 10 ppm, 12 ppm, 14 ppm, 20 ppm, 25 ppm or 50 ppm by volume, or higher than 2.5 mg/m³, 5 mg/m³, 10 mg/m³, 15 mg/m³, 20 mg/m³, 30 mg/m³, 50 mg/m³, 100 mg/m³, or higher than 150 mg/m³.

Unstained Printed Substrate:

As the polymer-containing immobilizing composition is designed to impart essentially no staining on the substrate, and/or designed not to alter substantially the original color of the substrate around the perimeter of the film (image), the substrate having the image printed thereon is substantially devoid of substrate color augmentation around the film.

A method for testing and measuring staining of a substrate may be carried out by visual inspection and evaluation of the color of the substrate near the edges of the film. Alternatively, staining and other color augmentation may be assessed by measuring a change in colorimetric parameters of the substrate, which is effected by measuring the colorimetric parameters of the substrate before printing the image, and comparing these parameters to the same after the image has been printed near the measured area (ΔE).

Colorimetric parameters, or color space, of a substrate may be defined by L* (lightness), a* and b* values on the L*a*b* scale. As used herein, the term “L*a*b*” or “Lab*” refers to the CIE L*a*b* (International Commission on Illumination or Commission Internationale d'Eclairage, CIE) color model. Used interchangeably herein and throughout, CIE L*a*b*, L*a*b* or Lab is the most complete color model used conventionally to describe all the colors and shades which are typically visible to a normal human eye. The three parameters in the model define a particular color, whereas the lightness of the color is represented by the parameter L*, wherein L*=0 corresponds to black and L*=100 corresponds to white. The value between true magenta and true green is represented by the parameter a*, wherein a negative value indicates green and a positive value indicates magenta. The value between true yellow and true blue is represented by the parameter b*, wherein a negative value indicates blue and a positive value indicates yellow.

For example, ΔE may be determined by measuring the difference in colorimetric parameters at two points on the substrate: a first point/area within the area on which a polymer-containing immobilizing composition has been applied (point 1), and a second point/area on the fabric where no polymer-containing immobilizing composition has been applied (point 2). In such cases, L*a*b*-based ΔE may be defined as [(L₁−L₂)²+(a₁−a₂))²+(b₁−b₂)²]^{0.5}.

Accordingly, a substrate substantially devoid of substrate color augmentation around the printed image (film), is one that no substantial difference in the colorimetric parameters is detected between the two points described above. Alternatively, a substrate substantially devoid of substrate color augmentation around the printed image (film), is defined as having ΔE lower than about 0.2, lower than 0.25, lower than 0.3, lower than 0.5, lower than 1, lower than 1.5, or lower than 2, based on measuring “point 1” and “point 2” in the substrate, recording CIE L*a*b* and calculating the difference in the CIE L*a*b* according to ΔE=[(L₁−L₂)²+(a₁−a₂)²+(b₁−b₂)²]^{1/2}.

A similar determination of immobilization and mitigation of bleeding can be carried out by measuring ink penetration through the substrate, and inks not intermixing thereon. Bleeding through the substrate the substrate can be measured by determining substrate ΔE on the back side of the image, and ink intermixing can be measured by determining ΔE on printed areas having distinct colors.

Wax as an Optional Additive:

According to some embodiments of the present invention, the immobilizing composition may optionally further include colloidal wax particles. The wax confers improved rub-resistance to the finished product (image). Suitable wax materials, according to some embodiments of the present invention, include homopolymers, oxidized homopolymers, copolymers, oxidized copolymers, polyolefins, paraffins, oxidized polyolefins poly-α-olefins, oxidized poly-α-olefins, ester-based waxes, polytetrafluoroethylene (PTFE) modified polyethylene waxes and mixtures thereof.

Waxes that may be used in the context of some embodiments of the present invention include, polyolefins such as polyethylene, polypropylene, and polybutene waxes such as commercially available from Allied Chemical and Petrolite Corporation, for example POLYWAX™ like including POLYWAX® 2000, POLYWAX® 1000, POLYWAX® 500, and the like from Baker Petrolite, Inc.; oxidized waxes such as X-2073 and Mekon waxes, from Baker-Hughes Inc.; polyethylene waxes such as from Baker Petrolite, wax dispersions available from BASF such as Joncryl wax 4, Joncryl wax 26, Joncyrl wax 28 and Joncryl wax 120 and from Michaelman, Inc. and the Daniels Products Company, EPOLENE N-15™ commercially available from Eastman Chemical Products, Inc., and VISCOL 550-P™; plant-based waxes, such as carnauba wax, rice wax, maydelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropschwax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate; and cholesterol higher fatty acid ester waxes, such as cholesteryl stearate.

Additional commercially available micronized (particulated) waxes include CERAFLOUR® 932 G, CERAFLOUR® 950, CERAFLOUR® 962, CERAFLOUR® 969, CERAFLOUR® 993 and the like, provided by BYK company.

Examples of functionalized waxes that may be used include amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer dispersion, for example JONCRYL 74™, 89™, 130™, 537″, and 538™, all available from BASF, and chlorinated polypropylenes and polyethylenes available from Allied Chemical and Petrolite Corporation and SC Johnson wax; and combinations thereof. Other suitable additives or materials as known to one of ordinary skill in the art may also be included in the wax dispersion.

The wax particles are typically suspended (stabilized) in the colloidal state by means of a dispersing agent, also referred to herein interchangeably as a surfactant or a surface-active agent, which stabilizes the colloids in terms of the particles capacity to stay dispersed and suspended in a liquid medium.

Surfactants may act as buffering agents, detergents, wetting agents, emulsifiers and dispersants. Surfactants are classified into families according to the charge or polarity of their head-group, namely into anionic, non-ionic and cationic surfactants. A nonionic surfactant has no charged groups in its head. The head of an ionic surfactant carries a net positive, or negative charge. If the charge is negative, the surfactant is more specifically called anionic; if the charge is positive, it is called cationic. If a surfactant contains a head with two oppositely charged groups, it is termed zwitterionic. In the context of embodiments of the present invention, the polymer-containing immobilizing composition may include anionic surfactants, nonionic surfactants, silicone surfactants, fluorosurfactants and combinations thereof.

In accordance with the present invention, suitable wax colloids include nonionic, anionic and cationic wax colloids. In general, nonionic wax colloids are stabilized using nonionic surfactants, cationic wax colloids are stabilized using cationic surfactants, and anionic wax colloids are stabilized using anionic surfactants. In the context of embodiments of the present invention, wax colloids are stable in acidic (pH<7) conditions, regardless of the nature of the surfactant. According to some embodiments of the present invention, the wax colloid is stabilized by cationic surfactants and is stable in acidic conditions. According to some embodiments of the present invention, the wax colloid is acidic.

It is noted herein that in the context of embodiments of the present invention, the wax and/or the wax-stabilizing surfactant, do not fall under the definition of a small molecule acid, also in the sense that it is non-volatile, and non-corrosive to the substrate and/or to parts of the printing machinery, and/or does not impart an odor or stains the substrate.

### Various Additives of Ink Compositions:

Following are descriptions and examples of various ingredients of the various compositions presented herein.

Exemplary film-forming agents include, without limitation, nonionic water-emulsifiable resins such as acrylic polymers and copolymers, alkyl-acrylic polymers and copolymers, acrylic-styrene copolymers, polyurethanes, polyethers, polyesters, polyacrylates and some combinations thereof.

According to some embodiments of the present invention, the film-forming agent is a self-crosslinking alkyl-acrylic copolymer, and according to some embodiments, the self-crosslinking alkyl-acrylic copolymer is an ethyl-acrylic/butyl-acrylic copolymer. Some acrylic-based polymers and copolymers are emulsifiable self-crosslinking polymers which are used in the garment industry to bestow physical and chemical resistance to the cloth, knitted, woven or non-woven, against physical wear and tear due to frequent use and repeated washing, as well as against alcohol, organic solvents and water.

When selected to have a low Tg, according to embodiments of the present invention, commercially available suitable film-forming agents, which may also serve as pigment dispersants in a relevant composition, include without limitation, TEXICRYL™ 13-216 (Tg −14° C.), TEXICRYL™ 13-290 (Tg −30° C.), TEXICRYL™ 13-297 (Tg −9° C.) and TEXICRYL™ 13-326 (Tg −25° C.) which are commercially available from Scott Bader Ltd., and APPRETAN™ E 2100 (Tg −30° C.), JONCRYL™ 617 (Tg +7° C.), APPRETAN™ E 6200 (Tg −20° C.) and APPRETAN™ E 4250 (Tg −15° C.) which are commercially available from Clariant.

Other non-limiting examples of commercially available film-forming agent ACRYSOL™ series, commercially available from Rhome and Hass Ltd., and ACRONAL™ series, commercially available from BASF Inc.

Other binders, dispersants and adhesion promoters which are useful in the context of an elastomeric film-forming agent according to embodiments of the present invention include, without limitation, commercially available and widely used families of products, known under names such as Alkydal™, Desmodur™ and Desmophen™ (from Bayer); Beckopox™, Macrynal™, Maprenal™, Viacryl™ and Vialkyd™ (from Vianova Resins); Cythane™ (from Cytec); Dynapol™ and Vestanat™ (from Hiils); Johncryl™ (from Johnson); K-Flex™ (from King Industries); Synocure™ and Synolac™ (from Cray Valley); Synthalat™ (from Synthopol); Tolonate™ (from Rhone Poulenc); Uracron™ and Uralac™ (from DSM); Worleecryl™ and Worleekyd™ (from Worlee) and the likes.

It is noted that any exemplary ingredient disclosed herein is given for exemplifying purposes only, and should not be regarded as limiting to that particular ingredient or commercially available product, but rather regarded as a representative member of a wider group of alternatives, all of which are meant to be encompassed in the context of other embodiments of the present invention.

Additional optional ingredients in the various compositions presented herein include surface active agents and viscosity modifying agents.

Exemplary surface active agents include, without limitation, polyether modified poly dimethyl siloxanes, polymethylalkylsiloxane, polyester hydroxyl modified poly-dimethyl-siloxane, a fluorocarbon/hydrocarbon anionic surfactant, a polyacrylic copolymer and any combination thereof.

Exemplary viscosity modifying agents include, without limitation, associative thickeners, Newtonian rheology additives, glycols, polyethyleneglycol, propylene glycol, triethylene glycol, diethylene glycol, glycerin, high molecular weight alcohols, carbowaxes, polyvinyl alcohols, polyvinyl pyrrolidones, and any combination thereof.

Exemplary anticorrosion agents include, without limitation, tolyltriazole (methylbenzotriazole, benzotriazole, and combinations thereof.

It is expected that during the life of a patent maturing from this application many relevant methods, uses and compositions will be developed and the scope of the terms methods, uses, compositions and polymers are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Immobilizing Composition an Acidic Polymer

An exemplary immobilizing composition comprising an acidic polymer, according to some embodiments of the present invention, is presented hereinbelow. This immobilizing composition is formulated to effect immobilization by congelation of an acid-sensitive soluble/emulsified polymeric binder which forms a part of an alkaline colored ink composition upon contact therebetween.

The following is a general makeup of a polymer-containing immobilizing composition, listing the ingredients with amounts given in percent by weight of the total weight of the composition.

| | |
|---|---|
| Acidic (anionic) polymer | 1-10% |
| Humectant | 10-40% |
| Thickening agent | 0-20% |
| Wetting agent/surfactant | 0-0.5% |
| Deionized water QS to | 100% |
| pH buffered to | 2-6 |

The following is an exemplary acidic polymer-containing immobilizing composition, according to some of embodiments of the present invention, which was prepared as follows:

| | |
|---|---|
| Sokalan ® PA 25 CL PN (polyacrylic acid dispersant) | 5% |
| Propylene glycol (humectant) | 25% |
| Collacral ® VAL (thickener) | 10% |
| BYK ®-3410 (wetting agent) | 0.2% |
| Lumiten ® EL (defoamer) | 0.1% |
| Deionized water QS to 100% | 56.7% |
| pH | 4 |

This composition was used in the following example to form images on cotton substrates, which were tested for their substrate staining and post-curing odor.

### Example 2

### Printing Test

The following is an exemplary process using the above-described exemplary acidic polymer-containing immobilizing composition, according to some embodiments of the present invention. It should be noted that this exemplary process is applicable for use in combination with other transparent or opaque colored ink compositions and opaque white (underbase) ink compositions, some of which are presented herein.

The exemplary printing process, according to embodiments of the present invention, was performed as follows:

A cotton textile substrate was placed in a printing machine equipped with a plurality of printheads (Kornit™ “Drop-On-Demand” Thunder™ inkjet printing machine.

An acidic polymer-containing immobilizing composition, comprising 5% of a commercially available anionic copolymer (Example 1), was loaded into a reservoir connected to a nozzle, whereas each of the transparent colored and white underbase ink compositions were loaded into a separate reservoir connected to a separate printhead.

The substrate was placed on the printing pallet, and the anionic copolymer dispersant immobilizing composition was applied on the substrate, followed substantially concomitantly with the printing of the white and colored ink compositions.

It is noted that in this example, while the white and colored ink compositions were applied using an inkjet printhead within the borders of the image (silhouette), the anionic copolymer dispersant immobilizing composition was sprayed more loosely using a nozzle applying a more coarse jet of droplets, covering a slightly larger area of the image. It is further noted that the same process can be carried out effectively using a printhead to apply the anionic copolymer dispersant immobilizing composition on the same area or an area that essentially overlaps with the image more precisely.

After the image has been formed, the substrate carrying the image was exposed to heat of 140° C. for curing.

The images which were formed by the above process were tested for qualitative odor and image-silhouette staining. The cured images could not be noted by their scent (odorless) and the perimeter of the image was not discolored or stained as assessed by bare eye.

### Example 3

The following is a description of a printing process wherein various colored ink compositions are used in conjunction with the acidic polymer-containing immobilizing composition, according to some embodiments of the present invention.

An acidic polymer-containing immobilizing composition is loaded into a mechanism that is configure to apply the composition onto the substrate based on a set of computer-generated actuation commands. Other separate printheads may be loaded with other ink compositions, such as:

A translucent cyan colored composition;

A translucent magenta colored composition;

A translucent yellow colored composition;

A translucent black colored composition; and

An opaque white underbase composition.

Optionally additional colored ink compositions such as green, red, light colors and others can be added in additional separate printheads so as to extend the range of color gamut/spectrum.

Once the portion of the substrate corresponding to the silhouette of the image is applied with the acidic polymer-containing immobilizing composition (see, for example, Examples 1 and 2), the printheads containing the opaque white composition and the printheads containing the CMYK compositions, may apply a mixture of opaque and/or translucent ink compositions over the same portion of the area where the dye has been discharged from the substrate.

It is noted that this process may be effected without applying an underbase layer of an opaque white colorant, particularly in substrates which are substantially white, or when the specific requirements allow the design to be printed over dyed background without further whitening thereof.

Optional Colored Composition:

A typical translucent colored composition, according to some embodiments of the present invention, generally formulated using ingredients wherein at least one of which is acid-sensitive in the sense that it caused the immobilization of the ink upon making contact with an acid. The following composition ingredients are provided with amounts given in percent by weight of the total weight of the composition:

| | |
|---|---|
| Pigment | 1.5-5% |
| Dispersant (can be acid sensitive) | 1-9% |
| Surfactants | 0.1-2.0% |
| Film-forming agent (can be acid sensitive) | 10-25% |
| Viscosity modifying agent/Humectant | 10-40% |
| Buffer (basic/amine) | 0.1-0.4% |
| Deionized water | QS to 100% |
| pH Buffering | higher than 7 |

The following exemplary translucent colored composition, according to some embodiments of the present invention, was prepared using an acid sensitive carboxylated polymer and/or an acid sensitive emulsified acrylic polymer:

| | |
|---|---|
| Pigment (C, M, Y or K) | 2-4% |
| Carboxylated polymer (Dispersant) | 5% |
| Surfactant Polyether dimethyl siloxane | 2% |
| Glycols/glycerin | 40% |
| Emulsified acrylic polymer (40-50% solid) | 30% |
| Carbodiimide crosslinker | 3% |
| (or melamine or melamine based | |
| crosslinker with carbamate functionality) | |
| Amine (buffering) | 0.1-0.4% |
| Deionized water | QS to 100% |
| pH buffered to | 7.5 |

Optional Opaque Underbase Composition:

A typical opaque underbase composition, according to some embodiments of the present invention, is generally formulated using at least one ingredient with is acid sensitive such that is caused the underbase composition to coagulate upon contacting an acid. The underbase composition is formed using the following ingredients, with amounts given in percent by weight of the total weight of the composition:

| | |
|---|---|
| Opaque white pigment | 8-12% |
| Dispersant (can be acid sensitive) | 4% |
| Surfactant | 0.3-0.6% |
| Defomer | 0.3-0.6% |
| Film-forming agent emulsion | 40-50% (solids) |
| (can be acid sensitive) | |
| Crosslinkers | 1-3% |
| Humectant | 35-50% |
| Buffer (basic/amine) | 0.1-0.4% |
| Deionized water | QS to 100% |
| pH buffered to | higher than 7 |

The following exemplary opaque underbase composition, according to some embodiments of the present invention, was prepared using an acid sensitive acrylic emulsion and/or an acid sensitive polyacrylate dispersant:

| | |
|---|---|
| Titania | 10% |
| High MW polyacrylate dispersant | 3.8% |
| Polyether dimethyl siloxane | 0.4% |
| Acrylate sodium salt | 1.5% |
| Glycols | 25% |
| Acrylic emulsion | 38% |
| Carbodiimide crosslinker | 3% |
| (or melamine or melamine based | |
| crosslinker with carbamate functionality) | |
| Tertiary Amine | 0.2% |
| Deionized water | QS to 100% |
| pH buffered to | 7.5 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An immobilizing composition, comprising an acidic polymer having a plurality of acidic functional groups attached thereto, and a carrier, wherein:
the composition is substantially devoid of a small molecule organic acid;
said plurality of acidic functional groups constitute from 40 percent to 70 percent by weight of the molecular weight of said acidic polymer; and
said acidic polymer lowers a pH level at a surface of a substrate thereby effecting immobilization of a pH-sensitive ink composition upon contacting said ink composition with the immobilizing composition on said surface.

2. The immobilizing composition of claim 1, having a pH that ranges from 2 to 6.

3. (canceled)

4. The immobilizing composition of claim 1, wherein said acidic functional groups are selected from the group consisting of carboxylic groups, phenol groups, sulfo groups, sulfino groups, aromatic sulfonamide groups, imide groups, phospho groups, phosphono groups and any combination thereof.

5. (canceled)

6. The immobilizing composition of claim 1, wherein said acidic polymer is characterized by at least one of:
a pKa that ranges from 3 to 5 in water;
an amount of said acidic polymer in the immobilizing composition ranges from 0.5% to 10% of the total weight of the composition;
water miscibility of at least 10%;
an odor threshold of said acidic polymer is higher than 1 ppm by volume of air;
an average molecular weight that ranges from 4000 g/mol to 20000 g/mol.

7-10. (canceled)

11. The immobilizing composition of claim 6, wherein said acidic polymer is selected from the group consisting of polyacrylic acid, acidic alkoxylated polymer, poly(2-acrylamido-2-methylpropanesulphonic acid), poly(acrylic acid-co-maleic acid), poly(butadiene-co-maleic acid), poly(ethylene-co-acrylic acid), polymaleic acid, poly(methacrylic acid), poly(4-styrenesulfonic acid-co-maleic acid), and any mixture thereof.

12. (canceled)

13. The immobilizing composition of claim 1, substantially devoid of a colorant.

14. The immobilizing composition of claim 1, suitable for direct inkjet printing from a nozzle and characterized by at least one of:
a maximal particle size of less than 15 micron;
a dynamic viscosity at shear that ranges from 2 to 4 (N·s)/m²;
a room temperature Brookfield viscosity less than 3 centipoises;
a surface tension that ranges from 24 to 26 N/m; and
an electrical resistance of 50 to 2000 ohm per centimeter.

15. (canceled)

16. The immobilizing composition of claim 1, suitable for direct inkjet printing from a printhead and characterized by at least one of:
a maximal particle size of less than 1 microns;
a dynamic viscosity at shear that ranges from 8 to 20 (N·s)/m²;
a room temperature Brookfield viscosity less than 25 centipoises;
a surface tension that ranges from 24 to 32 N/m; and
an electrical resistance of 50 to 2000 ohm per centimeter.

17-28. (canceled)

29. A substrate having an image printed thereon, wherein the image is in the form of a film attached to the substrate and said film is formed by contacting the substrate with the immobilizing composition of claim 1, and applying said ink composition on the substrate, thereby forming the image.

30. The substrate of claim 29, wherein an odor threshold of said film is higher than 1 ppm by volume of air.

31. The substrate of claim 29, substantially devoid of substrate color augmentation around said film.

32. An inkjet printing kit comprising the immobilizing composition of claim 1 and said ink composition.

33-34. (canceled)

35. A process of printing an image on a substrate, comprising contacting at least a portion of the substrate with the immobilizing composition of claim 1, and applying said ink composition on said portion of the substrate, thereby printing the image.

36. The process of claim 35, wherein said immobilizing composition and said ink composition are each individually applied on said portion of the substrate by a separate applicator.

37-38. (canceled)

39. The process of claim 36, wherein said immobilizing composition and said ink composition are applied concertedly, concomitantly or sequentially.

40. (canceled)

41. The process of claim 39, wherein said ink composition is applied on said substrate while said substrate is still wet with said immobilizing composition.

42. The process of claim 35, further comprising curing the image subsequent to said applying said ink composition.

43. The kit of claim 32, wherein said ink composition comprises a colorant, a pH-sensitive agent and a carrier.

44. The kit of claim 43, wherein said pH-sensitive agent is in a form of a dispersed agent and/or emulsified agent.

45. The kit of claim 44, wherein pH-sensitive agent is selected from the group consisting of a resin binder, a dispersing agent, an adhesion promoting agent and a film-forming agent.

46. The kit of claim 43, wherein said pH-sensitive agent is an emulsified or dispersed alkali-soluble polymer selected from the group consisting of a polyacrylate, a polyurethane, a polyether, a polyester, a polyvinyl chloride, a polyvinyl acetate, a polyvinyl butyral, an aminosilicon and any co-polymer, salt or combination thereof.
